(19) United States
(12) Patent Application Publication
(10) Pub. No.: US 2005/0060436 A1
(43) Pub. Date: Mar. 17, 2005

(54) Method and system for providing wireless communications between electronic devices

(76) Inventor: Juergen Kienhoefer, Santa Cruz, CA (US)

Correspondence Address: PATRICK REILLY, BOX 7218, SANTA CRUZ, CA, 95061-7218, US

(21) Appl. No.: 10/662,075

(22) Filed: Sep. 12, 2003

(51) Int. Cl. G06F 3/00

(52) U.S. Cl. 710/1

(57) ABSTRACT

A method, computer system and computer-readable medium for providing a communications connection between two electronic devices. The communications connection may be wireless. A first module may transmit an out put signal and a second module may receive and translate the output signal into a second format, wherein an electronic device communicatively linked to the second module may accept and read the input signal. The modules may each have hard connection fixtures that are fitted to conform to standardized form, fit and function rules to comply with general I/O channel standards such as USB, GPIB, or RS-232 standards.

### FIELD OF THE INVENTION

The present invention relates to the wireless communications systems and techniques useful in communicatively linking electronic devices. More particularly, the present invention relates to enabling electronic input-output devices to communicate via wireless modalities electronic device input/output (“I/O”) standards in wireless and consumer device transmission formats and standards.

### BACKGROUND OF THE INVENTION

Electronic devices are often communicatively linked to increase their usefulness. Yet the protocols, hardware, and electronics communications systems and software used to establish communications are often incompatible. Backward compatibility may be frustrated by the rapidity of software and hardware upgrades. As one example of a source of incompatibility between electronic devices, system software and/or the operating system (“OS”) included in many electronic devices, such as personal computers (“PC's”), may lack compatibility with earlier system software or OS versions, application software or necessary device drivers. In addition, the mechanical fitting of electrical-mechanical connections to unidirectional or bidirectional signal ports of the electronics devices must be in conformance with a subject electronic device.

Users of electronic systems and consumer products may often increase the utility of an electronic device by enabling communication between the device and one or more other electronic devices. The prior art use electrical signal cables (“cables”), such as suitable coaxial cables and other suitable electrical signal conductive wires and signal paths known in the art is widespread in businesses, offices and homes. Cables are used in a broad range of equipment ranging from home to automotive to industrial. Recently, advances in wireless technology have encouraged the replacement of cables with wireless connections. In addition, several standard software and hardware interfaces have been adopted by major electronics manufacturers and are increasingly designed into new electronic device product designs.

Opportunities unaddressed by the prior art exist both in designing wireless connections into devices and also in providing cable equivalents for use with devices still designed to use physical cables. Replacing a cable with a wireless communications link may often benefit users by solving common problems associated with cables, to include physical safety dangers, inconveniences, and costs. Replacing a cable with a wireless communications link may further eliminate the complexities of setting up software and configuring devices in more complex configurations. As cables are used in many markets and market segments such as consumer electronics, computers, medical, automotive and industrial equipment, the replacement of a cable by provision of a wireless link may serve the needs and desires of millions of users. In addition, electronic device manufacturers would gain by a system that establishes a wireless link between or among electronic devices and that reduces costs in software development, software version distribution and maintenance.

There is, therefore, a need for a method and a system that provides a wireless communications link between electronic devices, wherein loading new software into the electronic devices is not required for extending device life or utility.

### OBJECTS OF THE INVENTION

It is an object of the present invention to provide a method that enables a wireless communications link between at least two electronic input-output devices.

It is an additional optional object of the present invention to provide a first module that may be physically connected with a first electronic device, and a second module that may be physically connected with a second electronic device, wherein the two modules provide wireless electronic communications between the electronic devices.

It is a further object of certain preferred embodiments of the present invention to enable bi-directional communication between at least two electronic devices.

It is another object of certain alternate preferred embodiments of the present invention to enable a plurality of electronic devices to communicate via wireless communications links such that controlling devices can effectuate and manipulate signal input into receiving devices without undue alteration, modification, or upgrade to computer operating systems, network layers, security issues, application software or device drivers.

It is yet another object of certain still alternate preferred embodiments of the present invention to provide a computer-readable medium that supports wireless communications between at least two electronic devices.

### SUMMARY OF THE INVENTION

Aspects of the present invention present a system and method for communicatively linking a first electronic device and a second electronic device, the first electronic device having a first communications channel fixture and the second electronic device having a second communications channel fixture, wherein the system comprises a first module and a second module, the first module having a first communications fixture (“first comms fixture”) and a first transmitter, the first comms fixture configured to fit the first communications channel fixture and provide a output signal from the first electronic device to the first transmitter. The first transmitter is for transmitting the output signal to the second module and the second module for having a second comms fixture, a translator, and a receiver. The second comms fixture is configured to fit the second communications channel fixture of the second device and provides an input signal to the second electronic device from the receiver, which receives the output signal from the first transmitter and provides the output signal to the translator. The translator comprises electronic circuitry for translating the output signal from a first format into the input signal having a second format, and the translator for provides the input signal to the second electronic device via the second comms fixture. The first transmitter may optionally function as a wireless communications signal transmitter and the receiver may be or comprise a wireless communications signal receiver configured to receive wireless transmissions from the first transmitter. In other embodiments, the output signal can be an audio analog signal or a digitized audio signal.

Certain alternate preferred embodiments of the present invention system provide wireless communications between a first electronic device and a second electronic device, wherein the first electronic device generates an output signal substantively in compliance with a first format, the output signal provided via an output signal channel of the first electronic device, and the second electronic device is configured to enable a Universal Serial Bus (“USB”) interface with an electronic device. The invented system may optionally comprise a first module and a second module, wherein the first module is configured to communicatively couple with the first electronic device and the second module configured to communicatively couple with the second electronic device. The first module may include a first connector and a transmitter, wherein the first connector is configured to communicatively couple with the output signal channel of the first device, and the first connector communicatively coupled with the transmitter, wherein the output signal is broadcast via the transmitter as a wireless communication. The second module may have a USB connector, a signal format converter circuit, and a wireless receiver, whereby the USB connector may be communicatively linked with the second electronics device. The wireless receiver is communicatively coupled with the converter circuit, and the wireless receiver is configured to receive the wireless transmission and provide the wireless transmission to the converter circuit. The converter circuit may have a translation element, wherein the translation element may be configured to accept the wireless transmission from the wireless receiver and to generate a substantively USB compliant signal by translating the wireless transmission from the first format into the substantively USB compliant signal. The converter circuit may be communicatively coupled with the USB connector, whereby the substantively USB compliant signal is provided to the second electronic device.

In certain still alternate preferred embodiments the first format may be an electrical audio format, a serial digital communications format, an analog video format, and/or a digital video format. In certain yet alternate preferred embodiments system of the transmitter is a first transceiver and the receiver is a second transceiver, whereby the first and second modules enable bi-directional communications between the first electronic device and the second electronic device. In certain other preferred embodiments first transceiver is a radio signal transceiver and the second transceiver is a radio signal transceiver. In certain still other preferred embodiments the first transceiver is an infrared transceiver and the second transceiver is an infrared transceiver.

Certain yet other alternate preferred embodiments of the present invention may be or comprise an invented system for providing wireless communications between a first electronic device and a second electronic device, where the first electronic device generates an output signal substantively in compliance with a first format, and the output signal is provided via an output signal channel of the first electronic device. The second electronic device may be configured to enable a Universal Serial Bus (“USB”) interface with an electronic device. The invented system may comprise a first module and a second module, where the first module is configured for communicative coupling with the first electronic device and the second module is configured for communicative coupling with the second electronic device. The first module may have a first connector, a converter circuit and a transmitter, where the first connector is configured to communicatively couple with the output signal channel of the first device and to accept the output signal, and the first connector is communicatively coupled with the converter circuit. The converter circuit may have a translation element, where the translation element is configured to accept the output signal from the first connector and may generate a substantively USB compliant signal by translating the output signal into the substantively USB compliant signal. The converter circuit may be communicatively coupled with the transmitter, whereby the substantively USB compliant signal may be broadcast as a wireless communication. The second module may have a USB connector and a wireless receiver, whereby the USB connector may be communicatively linked with the second electronics device. The wireless receiver may be communicatively coupled with the USB connector, and the wireless receiver may be enabled for receiving the wireless transmission and providing the wireless transmission to the USB connector, whereby the substantively USB compliant signal is provided to the second electronic device. The first format may optionally be an electrical audio format, a serial digital communications format, an analog video format, and/or a digital video format. The transmitter may optionally be a first transceiver and the receiver may optionally be a second transceiver, whereby the first and second modules enable bi-directional communications between the first electronic device and the second electronic device. The first transceiver may optionally be or comprise a radio signal transceiver and the second transceiver may optionally be a radio signal transceiver. Alternatively or additionally, the first transceiver may optionally be an infrared transceiver and the second transceiver may optionally be an infrared transceiver.

Certain other alternate preferred embodiments of the present invention may be or comprise a system having a first module and a second module, where the first module is configured for communicative coupling with the first electronic device and the second module is configured for communicative coupling with the second electronic device. The first module may comprise a first connector and a transmitter, where the first connector is configured to communicatively couple with the output signal channel of the first device, and the first connector is enabled to communicatively couple with the transmitter, and the output signal may be broadcast via the transmitter as a wireless communication. The second module may have a conforming connector, a signal format converter circuit, and a wireless receiver, wherein the conforming connector may be configured to conform with the communications standard and may be communicatively linked with the second electronics device. The wireless receiver may be communicatively coupled with the converter circuit, and the wireless receiver may be enabled for receiving the wireless transmission and providing the wireless transmission to the converter circuit. The converter circuit may have a translation element, where the translation element may be configured to accept the wireless transmission from the wireless receiver and to generate a substantively compliant signal by translating the wireless transmission from the first format into the substantively compliant signal in substantive compliance with the communications, and the converter circuit communicatively coupled with the conforming connector, wherein the substantively compliant signal is provided to the second electronic device. The substantively compliant signal may be substantially in conformance with a communications signal standard selected from the group consisting of RS232, RS422, NTSC/PAL, JPEG, MPEG, PCM, IDE/Flash, other suitable communications signal standard known in the art. The output signal may be substantially in conformance with a communications standard selected from the group consisting of Bluetooth, IEEE802.11, GMS, CDMA, TDMA, and Ultrawide Band, other suitable communications standard known in the art. The conforming connector may be substantially in conformance with a connector standard selected from the group consisting of USB, IEEE1394, PCI, and PCMCIA, or other suitable connector standard known in the art.

Certain yet other alternate preferred embodiments of the present invention, or Serial/USB Sets, include a first module containing a serial port connector and a first transceiver, and a second module that includes a USB connector, a serial to USB data format converter, and a second transceiver. The first module of the Serial/USB Set may be configured to accept a serial data input from a printer, or another suitable serial signal emitting electronic device known in the art, and to transmit the serial data input to the second module via the first transceiver and the second transceiver. The second module then converts the serial signal as received by the second transceiver into a USB formatted signal, and provides the USB formatted signal via the USB connector to a USB enabled electronic device, such as a USB enabled personal computer, or other suitable USB enabled electronic device known in the art.

Certain yet additional alternate preferred embodiments of the present invention, or USB/Audio Sets, include (1) a first module containing an audio device connector, a digital to audio decompression and reformatting circuit, and a wireless receiver, and (2) a second module that includes a USB connector, a digital data compression circuit, and a wireless transmitter. The wireless transmitter and the wireless receiver are matched to respectively transmit and receive digital signals. The USB connector of the second module accepts a first digital signal via a USB port of an electronic device, such as a suitable audio CD player, and the digital data compression circuit then converts the first digital signal into a compressed digital file. The compressed digital signal is then transmitted via the wireless transmitter of the second module to the wireless receiver of the first module. The compressed digital signal is then decompressed and converted into an audio signal by the digital to audio decompression and reformatting circuit. The first module then provides the audio signal via the audio device connector to a first electronic device, such as a suitable audio speaker or other suitable audio device known in the art.

Still other alternate preferred embodiments of the present invention may be or comprise a method for using a computer-readable medium, the computer-readable medium carrying one or more sequences of one or more instructions for buffering data, wherein the execution of the one or more sequences of the one or more instructions by one or more processors, causes the one or more processors to perform one or more of the steps of:
>providing a first module and a second module;
>a first module and a second module, the first module configured for communicative coupling with the first electronic device and the second module configured for communicative coupling with the second electronic device;
>the first module having a first connector and a transmitter, the first connector configured to communicatively couple with the output signal channel of the first device, and the first connector communicatively coupled with the transmitter, wherein the output signal is broadcast via the transmitter as a wireless communication;
>the second module having a USB connector, a signal format converter circuit, and a wireless receiver, wherein the USB connector is communicatively linked with the second electronics device;
>the wireless receiver communicatively coupled with the converter circuit, and the wireless receiver for receiving the wireless transmission and providing the wireless transmission to the converter circuit;
>the converter circuit having a translation element, the translation element configured to accept the wireless transmission from the wireless receiver and to generate a substantively USB compliant signal by translating the wireless transmission from the first format into the substantively USB compliant signal, and the converter circuit communicatively coupled with the USB connector, wherein the substantively USB compliant signal is provided to the second electronic device;
>providing the computer-readable medium as or by means of a reprogrammable element; and
>providing a first transceiver comprising the transmitter and providing a second transceiver comprising the receiver, whereby the first and second modules enable bi-directional communications between the first electronic device and the second electronic device.

### BRIEF DESCRIPTION OF THE DRAWINGS

These, and further features of the invention, may be better understood with reference to the accompanying specification and drawings depicting the preferred embodiment, in which: These, and further features of the invention, may be better understood with reference to the accompanying specification and drawings depicting the preferred embodiment, in which:

FIG. 1 is a schematic diagram of a prior art wireless communications system;

FIG. 2 illustrates a first preferred embodiment of the present invention comprising a speaker and a controller;

FIG. 3 is a flowchart of the first preferred embodiment of the method of the present invention that may be performed by means of the first preferred embodiment of the present invention of FIG. 2;

FIG. 4 illustrates a second preferred embodiment comprising a blue tooth wireless link;

FIG. 5 is a flowchart of the second preferred embodiment of the method of the present invention that may be performed by means of the second preferred embodiment of the present invention of FIG. 4;

FIG. 6 illustrates a third preferred embodiment of the present invention wherein a plurality of electronic devices are communicatively linked with a personal computer;

FIG. 7 is an exemplary alternate preferred embodiment of the present invention;

FIG. 8 is a representation of an information technology system comprising a computer system, a computer-readable medium and an information technology system by which the method of the present invention of FIG. 3 may be executed via the exemplary alternate preferred embodiment of the present invention of FIG. 7;

FIG. 9 is schematic diagram of an alternate preferred embodiment of the present invention or Serial/USB Set.

FIG. 10 is schematic diagram of an additional alternate preferred embodiment of the present invention or USB/Audio Set.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

Other aspects of the present invention include a method, system and a computer-readable medium configured to carry out the foregoing steps. The foregoing and other objects, features and advantages will be apparent from the following description of the preferred embodiment of the invention as illustrated in the accompanying drawings.

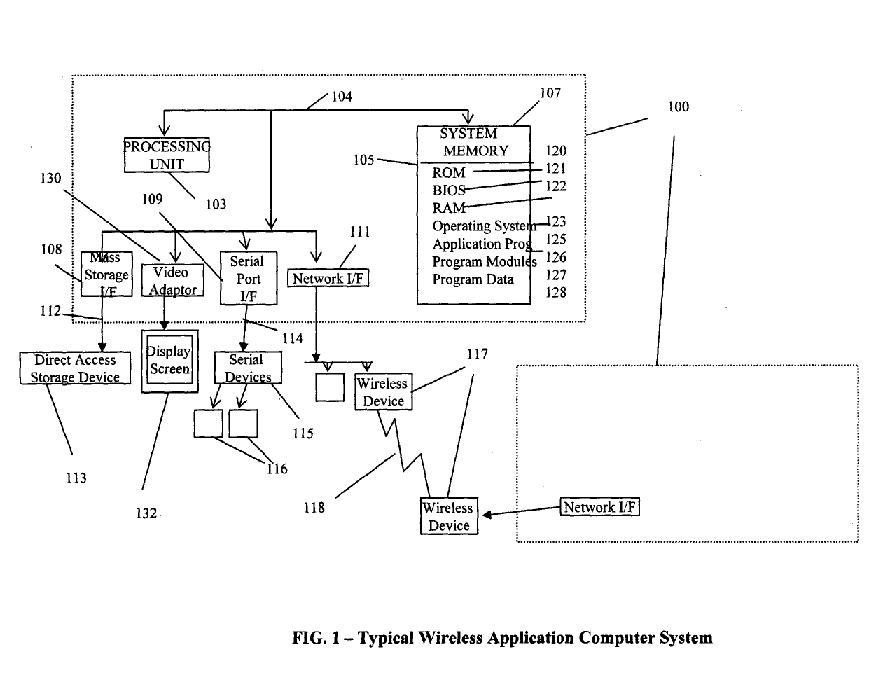

Referring now generally to the Figures and particularly to FIG. 1, FIG. 1 is a schematic diagram of a prior art wireless communications system. A computer system 100 is a computational electronic device, such as a networked personal computer workstation having at least one Central Processing Unit 103, Memory 107, network interface card 111, Display Screen 132, Mass Storage interface 108 for such devices 113 as hard drive(s) removable disk drives, optical disk storage, floppy drives, I/O buses 112 and 114, Memory Buses 104, etc. For purposes of illustration, embodiments of the invention are provided in the context of a word processor or email software program and its requirements.

Computer system 100 includes at least one processor unit 103, which obtains instructions and data via a system bus 104 from a main memory 107. Illustratively, the processor is a PowerPC available from IBM or a level of Pentium processor from Intel. More generally, however, any processor configured to implement the methods of the present invention may be used to advantage. The main memory 107 could be one or a combination of memory devices, including Random Access Memory 122, nonvolatile or backup memory, (e.g., programmable or Flash memories, read-only memories, etc.) and the like. In addition, memory 107 may be considered to include memory physically located elsewhere in a computer system 100, for example, any storage capacity used as virtual memory or stored on a mass storage device 113 or on another computer coupled to the computer system 100 via system bus 104. Illustratively, the main memory 107 contains executable software programs, which manage the hardware and control the software programs 105. The ROM 120, BIOS 121, and Operating System 125 are a system of software programs, which manage the hardware and software resources for the use and running of application software programs (“application programs”). The memory 107 further contains an application program 126 specifically, an email application program, a word processor application program, a text editor application program, a publishing tool application program, a web builder application program, or other suitable application program known in the art, for purposes of an embodiment of the present invention. In one embodiment, the application program is an email application program. Since email application programs have been ported to most computational systems, software platforms, and operating systems currently in use in the market place, many of the users may possibly benefit from aspects of the present invention and serve to broaden the scope of the invention. Program modules 127 and Program data 128 might optionally be resident in main memory 107, and optionally along with other software programs 125 which can be paged or swapped in from other memory sources, local 108 or networked 117. Software components and objects are but parts of software programs, which reside together in various regions of addressable memory and are executed to produce the necessary application program functions. Software components and objects themselves can be broken down into data structures and programming logic which use the data structures. Generally, program modules 127 include processes, software programs, objects, components, data structures, etc. that perform particular tasks or implement particular abstract data types.

The computer system 100 includes a number of operators and peripheral systems. Illustratively, these elements may include a mass storage interface 108 operably connected to a direct access storage device 113, which can be such suitable devices known in the art as hard disks, optical disk drives, floppy disk drives, optical storage, at least one input/output (I/O) interface 109 operably connected to I/O devices 115 such as modems, wireless broadcaster devices, audio, communication via serial protocol bus 114 such as IEEE 82xx, Firewire, RS232 etc, and a network interface 111 operably connected to a plurality of networked devices 117 which can be mass storage, other computers, wireless devices and other networked devices. The I/O devices 114 may optionally include a single or a combination of displays, keyboards, track point devices, mouse devices, speech recognition devices and the like. In some embodiments, the I/O devices are integrated, such as in the case of a touch screen. The networked devices 117 could be displays, desktop or PC-based computers, workstations, or network terminals, or other networked computer systems. As such, aspects of the invention can be practiced on a single computer system as well as over a network of computer systems.

A number of program modules may be stored on the mass storage device 113, ROM 120 or RAM 122, including an operating system 125, one or more application programs 126, other program modules 127, and program data 128. A user may enter commands and information into the workstation 100 through input serial devices 115 such as a keyboard or pointing device. Other input-output devices 116 may include a microphone, joystick, game pad, satellite dish, scanner, and/or other suitable devices known in the art

These and other input devices may be connected to the processing unit 103 through a serial port interface 115 that is coupled to the system bus 123, but may be connected by one or more other suitable interfaces known in the art, to include a parallel port, a game port or a universal serial bus (USB). A monitor 132 or other suitable type of display device known in the art may also be connected to the system bus 123 via a suitable interface known in the art, such as a video adapter 108. In addition to the video monitor 132, personal computers typically include other peripheral output devices (not shown), such as speakers and printers.

The personal computer workstation 100 may operate in a networked environment using logical connections to one or more remote computers, such as a remote computer 117. The remote computer 117 may be another personal computer, a server, a router, a network PC, a peer device or other common network node, or other suitable electronic device known in the art, and may include one, many or all of the elements described above relative to the personal computer 100. The logical connections depicted in FIG. 1 include a local area network (LAN) and a wide area network (WAN). Such networking environments may be found in many offices, enterprise-wide computer networks, intranets and Internet.

When used in a LAN networking environment, the personal computer 100 may be connected to the local network 117 through a network interface or adapter 111. When used in a WAN networking environment, the personal computer 100 can connect via modem 115 or other means for establishing communications over the wide area network 117, such as the Internet. The modem 115, which may be internal or external, is connected to the system bus 114 via the serial port interface 109. In a networked environment, program modules depicted relative to the personal computer 100, or portions thereof, may be stored in the remote memory storage device. It will be appreciated that the network connections shown are exemplary and other means of establishing a communications link between the computers may be used. For example, wireless devices with screens are becoming more prevalent. These are used for textual communication on cell phones, PDAs, Internet devices and combinations of these devices and are all within scope of the instant invention.

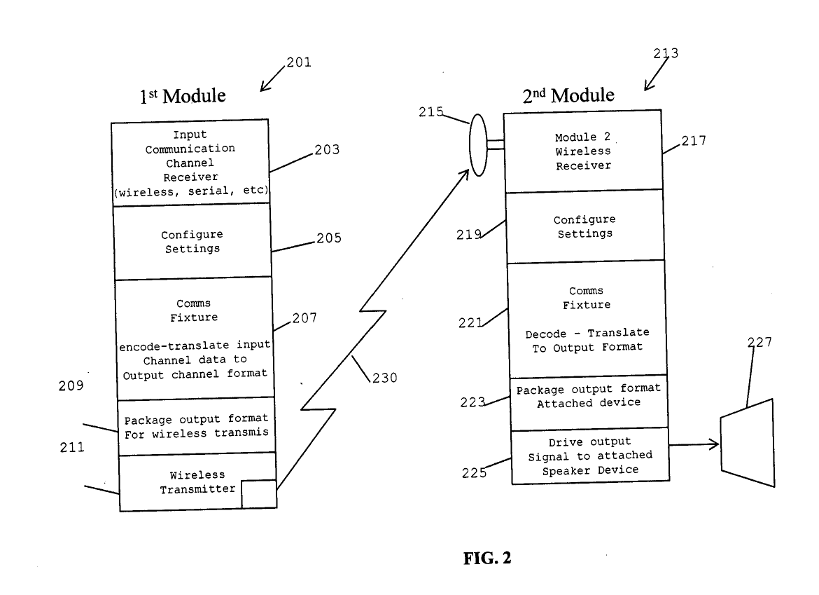

Referring now generally to the Figures and particularly to FIG. 2, FIG. 2 illustrates a first preferred embodiment of the present invention comprising a speaker and a controller. The typical computer system is replaced with a first electronic module 201 and a second electronic module 213. An aspect of the invention precludes the need for a second computer, communicating directely from the first electronic module 201 to a second electronic module 233. Module 201 communicates directly with module 2 which is connected to the external output speaker device 227. The first module 201 is comprised of an input channel receiver 203, setting configuration interface 203, comms fixture 207, wireless packager 209, and a wireless transmitter 211. The transmitter 211 transmits the signal via a wireless standard 230 to a second module 213. The second module 213 processes the signal for the purposes of driving an output speaker device 227. The second module 213 comprises a wireless receiver antenna 215, wireless signal receiver 217 electronics, configuration setting interface 219, a comms fixture 221, a package output channel formatter 223, output channel driver 225, and an attached external speaker device 227 to which the original input signal in the first module input channel 203 was targeted.

The first module 201 takes an input stream which can drive a remote device and configuration setting which direct the module to translate, encode, package for wireless transmission and transmit the datastream to a second module. First module 201 accomplishes this by accepting an input datastream through its input communication channel 203 which can be a wireless or physical bus, using configuration settings 205 or datastream inspection to determine the input datastream format or standard so that the datastream can be translated and encoded 207 to a standard format which can be read and used by a second module 213. The first module must package the datastream 209 for wireless transmission by a transmitter 211 to a wireless antenna 215 on the second module via a wireless standard 230 link between the two modules.

The second module's 213 function is to receive wireless datastream, decode the received datastream in accordance with its configuration settings and drive a compatible signal to the attached external device datastream target such as a speaker 227. The second module receives the wireless signal 217 and uses configuration settings and or datastream information to determine the type of data; audio, video, pictures, etc and the format, USB, serial-USB, audio-USB, GBIB, RS-232 etc of the received datastream. The second module comms fixture 221 decodes and translates the datastream to the attached output device signal specification channel format. This translated data is packaged 223 and if need be buffered to provide a standard signal 225, an analogy audio signal here, which can drive the attached output speaker device 227.

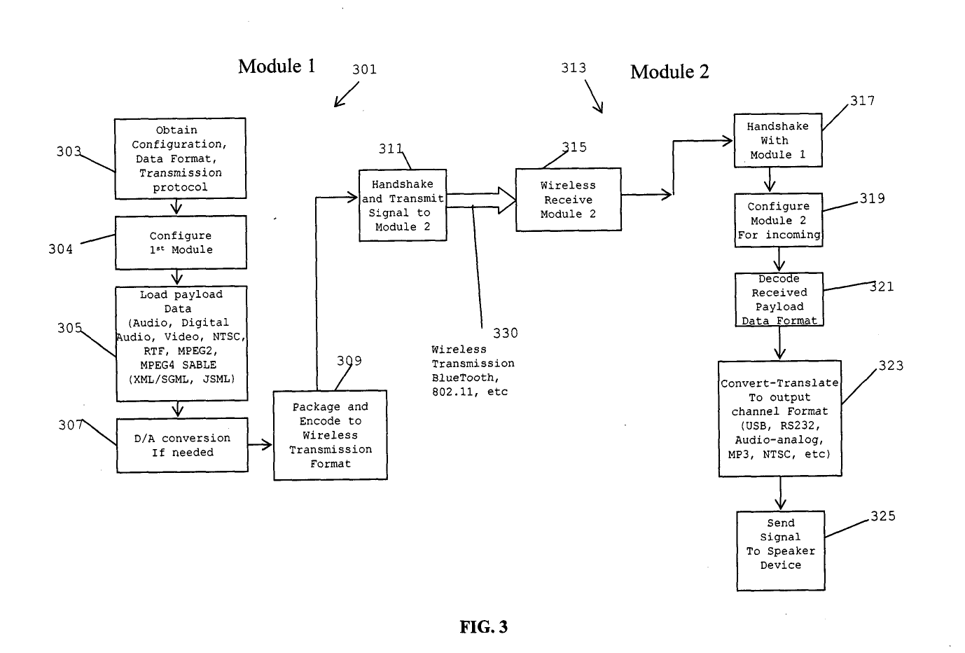

Referring now to FIG. 3, FIG. 3 is a flowchart of the first preferred embodiment of the method of the present invention that may be performed by means of the first preferred embodiment of the present invention of FIG. 2.

The first module 301 and the second module 313 are electronic devices and are such composed of electronic components which in this embodiment, are partitioned in the following architecture. The datastream to be wirelessly transported to the electronic device, or speaker 325, is obtained through a wireless antenna or a standard input spigot 303 standard which can be wireless or other bus standard, where the datastream is buffered and analyzed for type of data, speed necessary, flow control parameters, transmission protocol. The specification and information is used to configure 304 the first module 301 to receive, decode and convert the datastream for further transmission 311. The received datastream 303 may be converted to an alternate standard if needed for the target device attached to the second module. Payload data can be converted 305 to alternate audio, video, file or network formats and passed to Digital-to-Analog 307 conversion if required. The processed datastream is encoded and packaged 309 for wireless standard transmission 311. This transmission along a wireless standard link 330 could be 802.11, Bluetooth, etc, would be preceded with typical identification and handshaking 311 with the second electronic module 313.

Upon receiving notice from the first module 301, the second module 313 wireless receiver 315 component would respond 317, identify and acknowledge acceptable channel data, datastream format and flow parameters, configure 319 the channel translation fixture 323 for the incoming datastream, and proceed to unpackage and decode 312 the received datastream. The channel translation fixture 323 would perform any necessary conversion and translation necessary to meet the attached output electronic device input channel specifications: serial USB, RS232, Audio-analog. MP3, NTSC, etc and pass this datastream on the driver components 325 which would then push a device acceptable signal to the attached device, in this embodiment an analogy audio signal for the speaker.

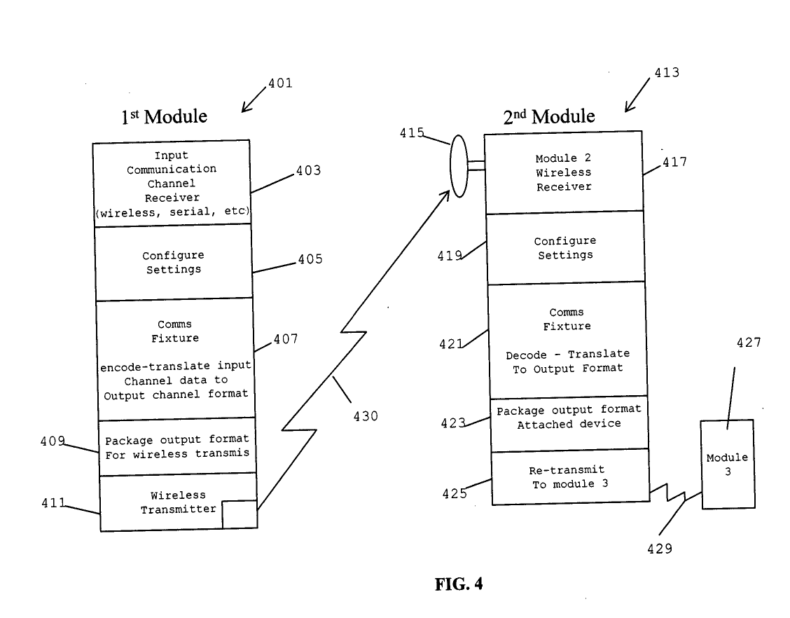

Referring now generally to the Figures and particularly to FIG. 4, FIG. 4 illustrates a second preferred embodiment comprising a Blue Tooth or 802.11 wireless link, or other suitable wireless communications link known in the art. The components 401, 403, 405, 407, 409, 411, 430, 413, 415, 417, 419, 421, 423 operate substantially similar to their FIG. 2 corresponding components 201, 203, 205, 207, 209, 211, 230, 213, 215, 217, 219, 221, 223. The embodiment described here further processes and packages the datastream for wireless re-sending 425 and thus functions somewhat like a repeater extending the range to a third or further link module 427 over wireless link 429. Module three 427 would itself be a repeater or the terminal module with the attached target datastream device.

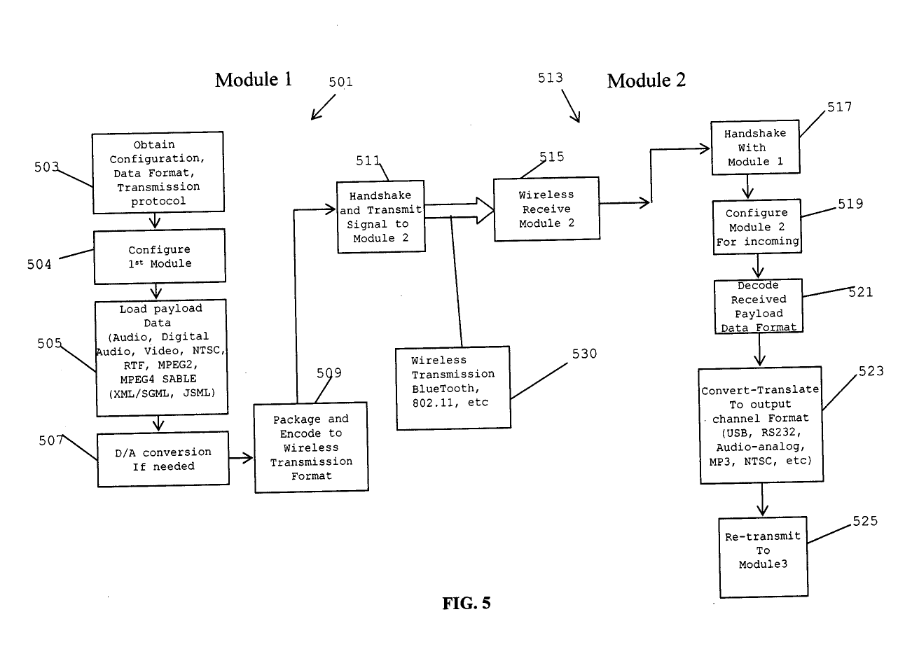

Referring now generally to the Figures and particularly to FIG. 5, FIG. 5 is a flowchart of the second preferred embodiment of the method of the present invention that may be performed by means of the second preferred embodiment of the present invention of FIG. 4;

The components 501, 503, 504, 505, 507, 509, 511, 530, 513, 515, 517, 519, 521, 523 function substantially similar to their FIG. 3 corresponding steps in 301, 303, 304, 305, 307, 309, 311, 330, 313, 315, 317, 319, 321, 323. The final step in the second preferred embodiment's second module 515 functions to package and re-transmit 525 the datastream to a further module three located strategically to necessitate the need for the repeater second module 513.

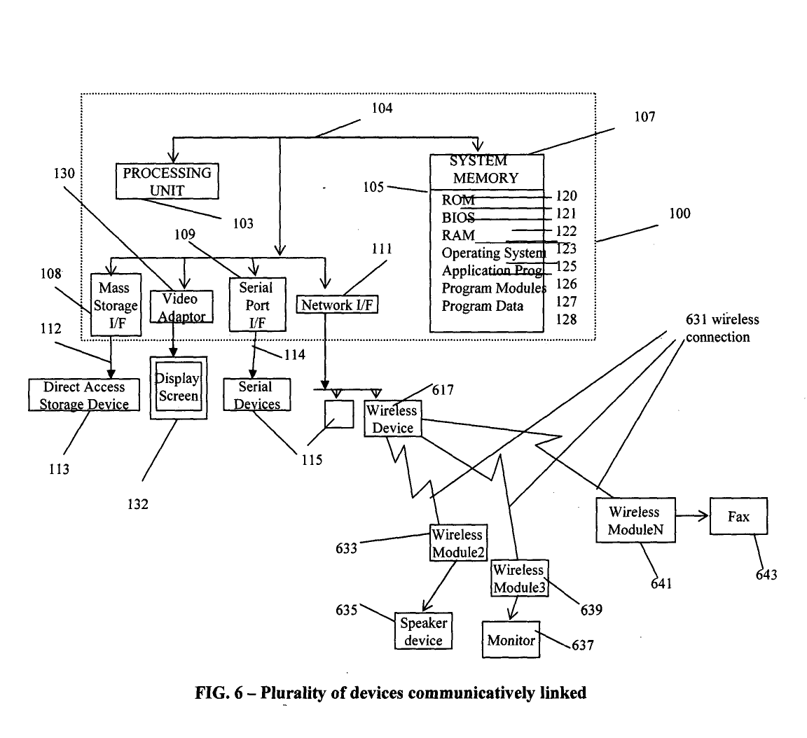

Referring now generally to the Figures and particularly to FIG. 6, FIG. 6 illustrates a third preferred embodiment of the present invention wherein a plurality of electronic devices are communicatively linked with a personal computer.

The computer system shown in FIG. 6 is substantially similar to the computer system shown in FIG.1 with the exception of the wireless devices 617, 633, 639, 641 which remotely operate to exploit connectionless functionality of devices 635, 637 and 643. In this embodiment, the wireless device 617 serves as the first module capacity to obtain datastream bound for a wireless connected target device 635, 637 and or 643, and provide datastreams for multiple receiver module two 633, 639 and 641 type devices. Applications for this embodiment include gatherings where wireless speakers can provide music, diverse audio channels, or voice to listeners without placing receiving computers in remote locations or Public Address systems. This third embodiment extends standalone monitors and other devices which can be used to function from wireless signals without the complication of various OS's, extra networking layers, and software applications. For example a digitized datastream from the host computer 100 can be transmitted via an embodiment of the present invention shown as 617 to a wireless module 639 which would receive and process the digitized datastream, convert the digital video to analog NTSC or RGB and drive signal to a monitor 637 which has its own power source.

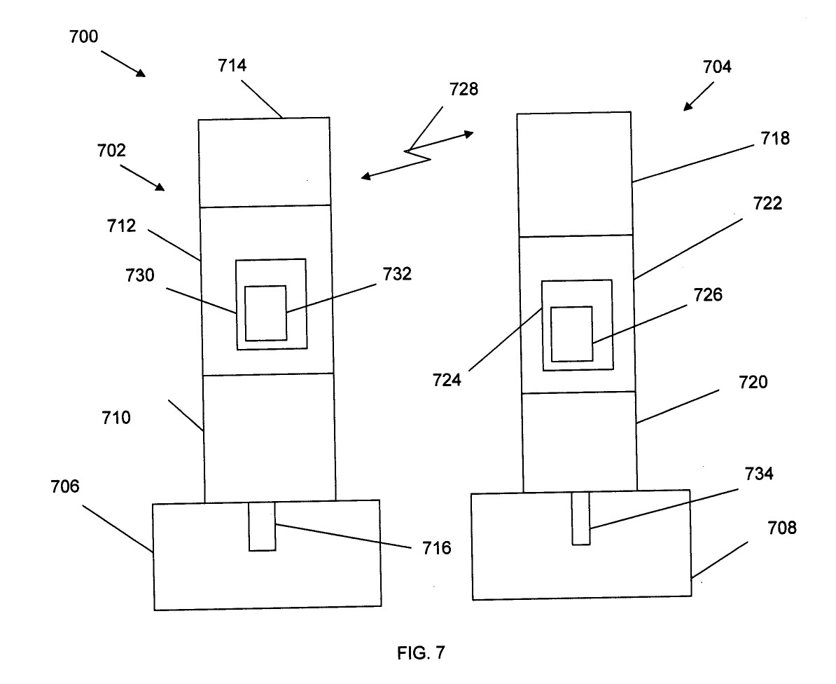

Referring now generally to the Figures and particularly to FIG. 7, FIG. 7 illustrates an exemplary alternate preferred embodiment of the present invention 700, or fourth version 700. The fourth version 700 has a first module 702 and a second module 704, the first module 702 configured for communicative coupling with a first electronic device 706 and the second module 704 is configured for communicative coupling with a second electronic device 708. The first module 702 includes a first connector 710, an optional first signal format converter 712, and a first transceiver 714. The first connector 710 is configured to communicatively couple with a first device signal channel 716 of the first device 706. The functionality of the first device signal channel 716 determines the opportunity for the first module 702 to support either unidirectional or bidirectional communication between the first electronic device 706 and the second electronic device 708. The first connector 710 may be configured to conform with a connector standard, such as a connector standard selected from the group consisting of suitable industry standards known in the art and to include the USB, IEEE1394, PCI, and PCMCIA standards. The first connector 710 is communicatively coupled with the transceiver 714, whereby an output signal originating from the first electronic device 706 may be broadcast via the first transceiver 714 to a second transceiver 718 of the second module 704 as a wireless communication. The second module 704 includes a conforming connector 720, a second optional signal format converter circuit 722, and the second wireless transceiver 718. The conforming connector 720 is configured to conform with a connector standard, such as a connector standard selected from the group consisting of suitable industry standards known in the art and to include the USB, IEEE1394, PCI, and PCMCIA standards. The conforming connector 720 is communicatively linked with the second electronics device 708. The conforming connector 720 is configured to communicatively couple with a second device signal channel 734 of the second electronics device 708. The functionality of the second device signal channel 734 determines the opportunity for the second module 704 to support either unidirectional or bidirectional communication between the first electronic device 706 and the second electronic device 708. The second optional signal format converter circuit 722 is communicatively coupled with the conforming connector 720 and the second wireless transceiver 718, for receiving the wireless transmission and providing a reformatted signal of the wireless transmission, as reformatted by the second optional signal format converter circuit 722, to the second electronic device 708. The second optional signal format converter circuit 722 includes a translation element 724, the translation element 724 configured to accept the wireless transmission from the second wireless transceiver 718 and to generate a signal substantively compliant to a second communications standard or format, such as by translating the wireless transmission from the first format into the substantively compliant signal in substantive compliance with the communications standard. The second communications standard or format may be selected from a group of suitable standards known in the art, to include RS232, RS422, NTSC/PAL, JPEG, MPEG, PCM, and IDE/Flash. A reprogrammable circuit 726 of the translation element 724 may be programmed or reprogrammed to determine which communications standard the substantively compliant signal is prepared to substantively or entirely comply with. The second optional signal format converter circuit 722 is communicatively coupled with the conforming connector 720, whereby the substantively compliant signal is provided to the second electronic device 708. The unidirectional or bidirectional communications between the first module 702 and the second module 704 may be substantially in conformance with a suitable communications standard known in the art, to include one of the standards of Bluetooth, IEEE802.11, GMS, CDMA, TDMA, and Ultrawide Band. The wireless communications link 728 is supported by the transceivers 714 and 718. The transceivers 714 and 718 may, in various alternate preferred embodiments of the present invention may comprise (1) a transmitter-receiver pair that supports unidirectional communication only or (2) a transceiver pair that supports bidirectional wireless communication. An optional translation element 730 is provided in certain alternate preferred embodiments of the first module 702 whereby a wireless communication received by the first transceiver 714 may be reformatted prior to transmission to the first electronic device 706 via the connector 710. In still other certain alternate preferred embodiments of the present invention the first module 702 further comprises the optional translation element 730 having an optional reprogrammable circuit 732. The optional reprogrammable circuit 732 may be programmed or reprogrammed determine which communications standard the wireless communication will be reformatted by the first module 702 to substantively or entirely comply with.

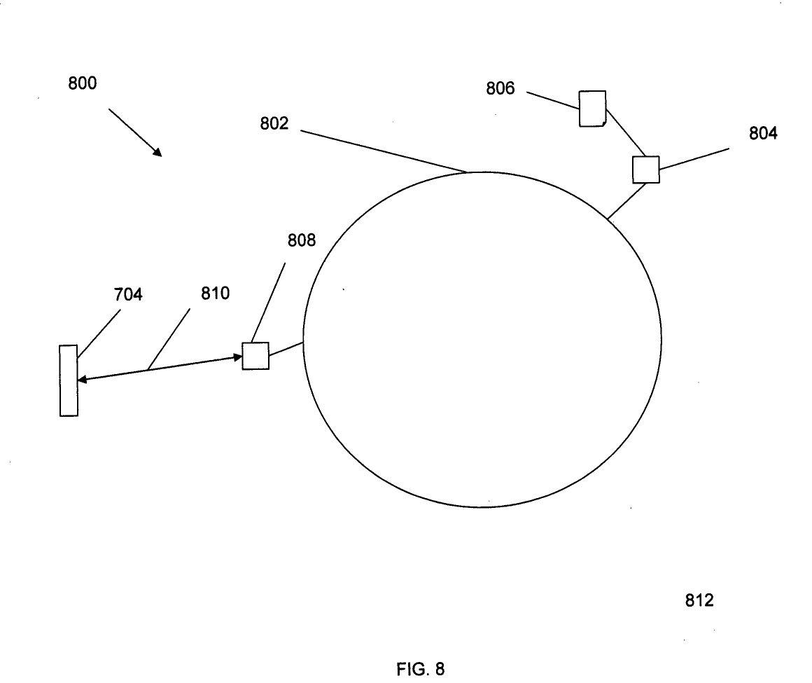

Referring now generally to the Figures and particularly to FIGS. 7 and 8, FIG. 8 shows an information technology system 800 comprising a computer network 802, computer system 804, a computer-readable medium 806 and a communications module 808 by which the method of the present invention of FIG. 3 may be executed via the exemplary alternate preferred embodiment of the present invention 700 of FIG. 7. The computer network 802 may be or comprise an Intranet, Extranet, Internet, telephone network, or other suitable electronic communications network known in the art. The reprogrammable circuit 726 of the translation element 724 may be programmed or reprogrammed to determine which communications standard the substantively compliant signal is prepared to substantively or entirely comply with by means formatting information transmitted from the computer-readable medium 806 to the reprogrammable circuit 726. The formatting information may be read from computer-readable medium 806 by the computer system 804 and then transmitted from the computer system 804 via the computer network 802 and to the communications module 808. The communications module 808 may then transmit, by a wireless or a hardwire link 810, the formatting information to the second module 704 and thereby reprogram the reprogrammable circuit 726.

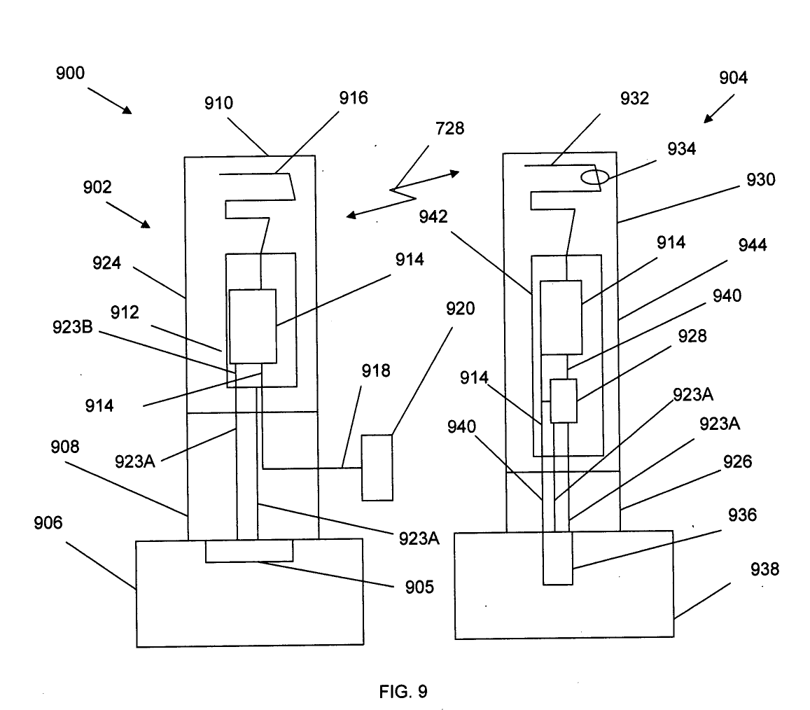

Referring now generally to the Figures and particularly to FIG. 9, an alternate preferred embodiment of the present invention 900, or Serial/USB Set 900, includes a first module 902 and a second module 904. The first module 902 is configured to be communicatively linked to a serial port 905 of a printer 906. The first module 902 contains a serial port connector 908 and a first transceiver 910. The first transceiver 910 includes a printed circuit board 912, a transceiver circuit 914, an aerial 916 and an electrical power line 918. The electrical power line 918 accepts an electrical power feed from an electrical power source 920 and delivers the electrical power to the first module 902 via power signal traces 922 of the circuit board 912. The transceiver circuit 914 may be a suitable wireless transmitter or wireless receiver device known in the art, such as a BC02 BLUETOOTH TRANSCEIVER as marketed by CSR Corporation of Cambridge Science Park, Milton Road, Cambridge, CB4 OWH, United Kingdom, or another suitable wireless transmitter or wireless transceiver known in the art. The transceiver circuit 914 receives a serial data signal from the serial port 905 via signal lines 923A of the serial port 906 and signal traces 923B of the printed circuit board 912. In addition, the transceiver 914 transmits the serial data signal and optionally receives wireless signals from the aerial 916. The aerial 916 and the first transceiver 910 are maintained in position by attachment to the printed circuit board 912. The printed circuit board 912 and the serial connector 908 are in turn attached to a housing 924 for stability and to maintain the serial connector 908 in communication with the first transceiver 910. The housing 924 may be constructed with metal, plastic, or composite material, or other suitable material known in the art.

The second module 904 of the Serial/USB Set 900 includes a USB connector 926, a serial to USB data format converter 928, and a second transceiver 930. The first module 902 of the Serial/USB Set 900 may be configured to accept a serial data input from the printer 906, or another suitable serial signal emitting electronic device known in the art, and to transmit the serial data input to the second module 906 via the first transceiver 910 and the second transceiver 930. The second transceiver 930 and the first transceiver 910 are matched and selected to communicatively link by wireless communications modes. The second transceiver 930 receives a wireless communication of the serial data signal from the first transceiver 910 by means of a second aerial 932 and after filtering by signal filters 934. The serial to USB data format converter 928 of the second module 904 then converts the serial signal as received by the second transceiver 930 into a USB formatted signal, and provides the USB formatted signal via the USB connector 926 to a USB port 936 of a USB enabled electronic device 938, such as a USB enabled personal computer, or other suitable USB enabled electronic device known in the art. The serial to USB data format converter 928 may be or comprise a FUTURE TECHNOLOGIES MODEL NUMBER FT 232 SERIAL DATA TO USB DATA CONVERTER or other suitable serial to USB data format converter known in the art. The serial to USB data format converter 928 and the second transceiver 930 receive electrical power from the via the USB port 936 via the USB connector 926 and a plurality of power lines 940 and the traces 914 of a printed circuit board 942. The USB connector 926, the serial to USB data format converter 928, and the second transceiver 930 are attached or coupled to the printed circuit board 942. A second housing 944 is attached to the printed circuit board 942 for stability and to maintain the USB connector 926 in communication with the second transceiver 930. The second housing 944 may be constructed with metal, plastic, or composite material, or other suitable material known in the art.

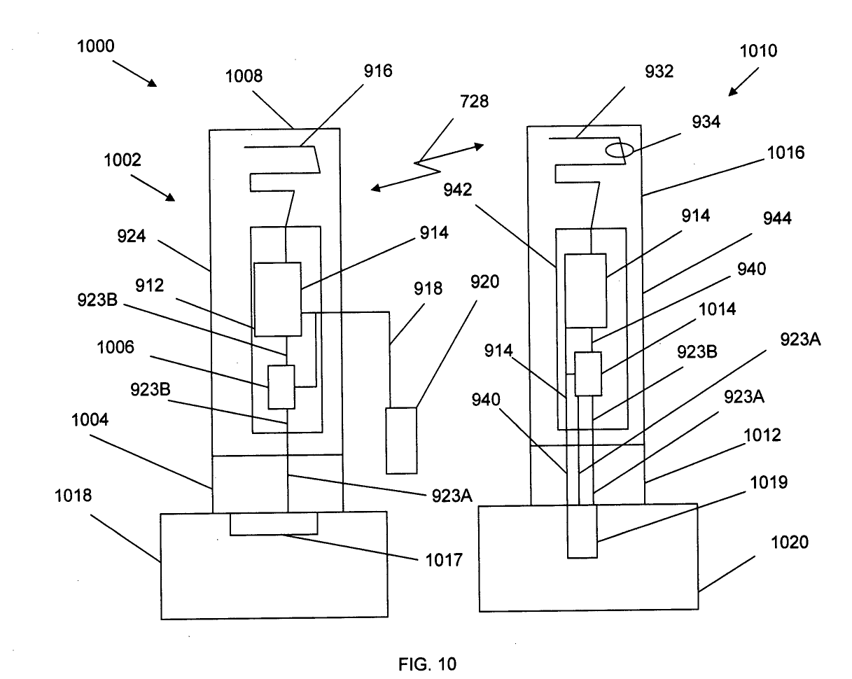

Referring now generally to the Figures and particularly to FIG. 10, an additional alternate preferred embodiment of the present invention, or USB/Audio Set 1000, include (1) a first module 1002 containing an audio device connector 1004, a digital to audio decompression and reformatting circuit 1006, and a wireless receiver 1008, and (2) a second module 1010 that includes a USB connector 1012, a digital data compression circuit 1014, and a wireless transmitter 1016. The first module 1002 is configured to be communicatively linked to an audio signal port 1017 of an audio speaker 1018. The wireless transmitter 1016 and the wireless receiver 1008 are matched to respectively transmit and receive digital signals. The USB connector 1012 of the second module 1010 accepts a first digital signal via a USB port 1019 of a USB-enabled electronic audio CD player 1020, and the digital data compression circuit 1014 then converts the first digital signal into a compressed digital file. The compressed digital signal is then transmitted via the wireless transmitter 1016 of the second module 1010 to the wireless receiver 1008 of the first module 1002. The compressed digital signal is then decompressed and converted into an audio signal by the digital to audio decompression and reformatting circuit 1006 of the first module 1002. The first module 1002 then provides the audio signal via the audio device connector 1004 to the audio speaker 1018 or other suitable audio device known in the art.

Certain alternate preferred embodiments of the present invention system provide wireless communications between a first electronic device and a second electronic device, wherein the first electronic device generates an output signal substantively in compliance with a first format, the output signal provided via an output signal channel of the first electronic device, and the second electronic device is configured to enable a Universal Serial Bus (“USB”) interface with an electronic device. The invented system may optionally comprise a first module and a second module, wherein the first module is configured to communicative couple with the first electronic device and the second module configured to communicative couple with the second electronic device. The first module may include a first connector and a transmitter, wherein the first connector is configured to communicatively couple with the output signal channel of the first device, and the first connector communicatively coupled with the transmitter, wherein the output signal is broadcast via the transmitter as a wireless communication. The second module may have a USB connector, a signal format converter circuit, and a wireless receiver, whereby the USB connector may be communicatively linked with the second electronics device. The wireless receiver is communicatively coupled with the converter circuit, and the wireless receiver is configured to receive the wireless transmission and provide the wireless transmission to the converter circuit. The converter circuit may have a translation element, wherein the translation element may be configured to accept the wireless transmission from the wireless receiver and to generate a substantively USB compliant signal by translating the wireless transmission from the first format into the substantively USB compliant signal. The converter circuit may be communicatively coupled with the USB connector, whereby the substantively USB compliant signal is provided to the second electronic device.

In certain still alternate preferred embodiments the first format may be an electrical audio format, a serial digital communications format, an analog video format, and/or a digital video format. In certain yet alternate preferred embodiments system of the transmitter is a first transceiver and the receiver is a second transceiver, whereby the first and second modules enable bidirectional communications between the first electronic device and the second electronic device. In certain other preferred embodiments first transceiver is a radio signal transceiver and the second transceiver is a radio signal transceiver. In certain still other preferred embodiments the first transceiver is an infrared transceiver and the second transceiver is an infrared transceiver.

Certain yet other alternate preferred embodiments of the present invention may be or comprise an invented system for providing wireless communications between a first electronic device and a second electronic device, where the first electronic device generates an output signal substantively in compliance with a first format, and the output signal is provided via an output signal channel of the first electronic device. The second electronic device may be configured to enable a Universal Serial Bus (“USB”) interface with an electronic device. The invented system may comprise a first module and a second module, where the first module is configured for communicative coupling with the first electronic device and the second module is configured for communicative coupling with the second electronic device. The first module may have a first connector, a converter circuit and a transmitter, where the first connector is configured to communicatively couple with the output signal channel of the first device and to accept the output signal, and the first connector is communicatively coupled with the converter circuit. The converter circuit may have a translation element, where the translation element is configured to accept the output signal from the first connector and may generate a substantively USB compliant signal by translating the output signal into the substantively USB compliant signal. The converter circuit may be communicatively coupled with the transmitter, whereby the substantively USB compliant signal may be broadcast as a wireless communication. The second module may have a USB connector and a wireless receiver, whereby the USB connector may be communicatively linked with the second electronics device. The wireless receiver may be communicatively coupled with the USB connector, and the wireless receiver may be enabled for receiving the wireless transmission and providing the wireless transmission to the USB connector, whereby the substantively USB compliant signal is provided to the second electronic device. The first format may optionally be an electrical audio format, a serial digital communications format, an analog video format, and/or a digital video format. The transmitter may optionally be a first transceiver and the receiver may optionally be a second transceiver, whereby the first and second modules enable bidirectional communications between the first electronic device and the second electronic device. The first transceiver may optionally be or comprise a radio signal transceiver and the second transceiver may optionally be a radio signal transceiver. Alternatively or additionally, the first transceiver may optionally be an infrared transceiver and the second transceiver may optionally be an infrared transceiver.

Certain other alternate preferred embodiments of the present invention may be or comprise a system having a first module and a second module, where the first module is configured for communicative coupling with the first electronic device and the second module is configured for communicative coupling with the second electronic device. The first module may comprise a first connector and a transmitter, where the first connector is configured to communicatively couple with the output signal channel of the first device, and the first connector is enabled to communicatively couple with the transmitter, and the output signal may be broadcast via the transmitter as a wireless communication. The second module may have a conforming connector, a signal format converter circuit, and a wireless receiver, wherein the conforming connector may be configured to conform with the communications standard and may be communicatively linked with the second electronics device. The wireless receiver may be communicatively coupled with the converter circuit, and the wireless receiver may be enabled for receiving the wireless transmission and providing the wireless transmission to the converter circuit. The converter circuit may have a translation element, where the translation element may be configured to accept the wireless transmission from the wireless receiver and to generate a substantively compliant signal by translating the wireless transmission from the first format into the substantively compliant signal in substantive compliance with the communications standard, and the converter circuit communicatively coupled with the conforming connector, wherein the substantively compliant signal is provided to the second electronic device. The substantively compliant signal may be substantially in conformance with a communications signal standard selected from the group consisting of RS232, RS422, NTSC/PAL, JPEG, MPEG, PCM, and IDE/Flash, other suitable communications signal standard known in the art. The output signal may be substantially in conformance with a communications standard selected from the group consisting of Bluetooth, IEEE802.11, GMS, CDMA, TDMA, Ultrawide Band, other and communications standard known in the art. The conforming connector may be substantially in conformance with a connector standard selected from the group consisting of USB, IEEE1394, PCI, and PCMCIA, or other suitable connector standard known in the art.

Still other alternate preferred embodiments of the present invention may be or comprise a method for using a computer-readable medium, the computer-readable medium carrying one or more sequences of one or more instructions for buffering data, wherein the execution of the one or more sequences of the one or more instructions by one or more processors, causes the one or more processors to perform one or more of the steps of:
>providing a first module and a second module;
>a first module and a second module, the first module configured for communicative coupling with the first electronic device and the second module configured for communicative coupling with the second electronic device;
>the first module having a first connector and a transmitter, the first connector configured to communicatively couple with the output signal channel of the first device, and the first connector communicatively coupled with the transmitter, wherein the output signal is broadcast via the transmitter as a wireless communication;
>the second module having a USB connector, a signal format converter circuit, and a wireless receiver, wherein the USB connector is communicatively linked with the second electronics device;
>the wireless receiver communicatively coupled with the converter circuit, and the wireless receiver for receiving the wireless transmission and providing the wireless transmission to the converter circuit;
>the converter circuit having a translation element, the translation element configured to accept the wireless transmission from the wireless receiver and to generate a substantively USB compliant signal by translating the wireless transmission from the first format into the substantively USB compliant signal, and the converter circuit communicatively coupled with the USB connector, wherein the substantively USB compliant signal is provided to the second electronic device;
>providing the computer-readable medium as or by means of a reprogrammable element; and
>providing a first transceiver comprising the transmitter and providing a second transceiver comprising the receiver, whereby the first and second modules enable bidirectional communications between the first electronic device and the second electronic device.

The term “computer-readable medium” as used herein refers to any suitable medium known in the art that participates in providing instructions to the network 2 for execution. Such a medium may take many forms, including but not limited to, non-volatile medium, volatile medium, and transmission medium. Non-volatile medium includes, for example, optical or magnetic disks, such as storage device 10. Volatile medium includes dynamic memory. Transmission medium includes coaxial cables, copper wire and fiber optics. Transmission medium can also take the form of acoustic or light waves, such as those generated during radio-wave and infra-red data communications.

Common forms of computer-readable medium include, for example, a floppy disk, a flexible disk, hard disk, magnetic tape, or any other magnetic medium, a CD-ROM, DVD, any other optical medium, punch cards, paper tape, any other physical medium with patterns of holes, a RAM, a PROM, and EPROM, a FLASH-EPROM, RAM, DRAM, SDRAM any other memory chip or cartridge, a carrier wave as described hereinafter, or any other medium from which a computer can read.

Various forms of computer readable medium may be involved in carrying one or more sequences of one or more instructions to the network for execution. For example, the instructions may initially be carried on a magnetic disk of a remote computer. The remote computer can load the instructions into its dynamic memory and send the instructions over a telephone line using a modem. A modem local to or communicatively linked with the network can receive the data on the telephone line and use an infra-red transmitter to convert the data to an infra-red signal. An infra-red detector can receive the data carried in the infra-red signal and appropriate circuitry can provide the data to the network.

Those skilled in the art will appreciate that various adaptations and modifications of the just-described preferred embodiments can be configured without departing from the scope and spirit of the invention. Other suitable fabrication, manufacturing, assembly, wire bonding and test techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

1. A system for providing wireless communications between a first electronic device and a second electronic device, the first electronic device generating an output signal substantively in compliance with a first format, the output signal provided via an output signal channel of the first electronic device, and the second electronic device configured to enable a Universal Serial Bus (“USB”) interface with an electronic device, the system comprising:
a first module and a second module, the first module configured for communicative coupling with the first electronic device and the second module configured for communicative coupling with the second electronic device;
the first module having a first connector and a transmitter, the first connector configured to communicatively couple with the output signal channel of the first device, and the first connector communicatively coupled with the transmitter, wherein the output signal is broadcast via the transmitter as a wireless communication;
the second module having a USB connector, a signal format converter circuit, and a wireless receiver, wherein the USB connector is communicatively linked with the second electronics device;
the wireless receiver communicatively coupled with the converter circuit, and the wireless receiver for receiving the wireless transmission and providing the wireless transmission to the converter circuit; and
the converter circuit having a translation element, the translation element configured to accept the wireless transmission from the wireless receiver and to generate a substantively USB compliant signal by translating the wireless transmission from the first format into the substantively USB compliant signal, and the converter circuit communicatively coupled with the USB connector, wherein the substantively USB compliant signal is provided to the second electronic device.

2. The system of claim 1, wherein the first format is an electrical audio format.

3. The system of claim 1, wherein the first format is a serial digital communications format.

4. The system of claim 1, wherein the first format is an analog video format.

5. The system of claim 1, wherein the first format is a digital video format.

6. The system of claim 1 wherein the transmitter is a first transceiver and the receiver is a second transceiver, whereby the first and second modules enable bi-directional communications between the first electronic device and the second electronic device.

7. The system of claim 6 wherein the first transceiver is a radio signal transceiver and the second transceiver is a radio signal transceiver.

8. The system of claim 6 wherein the first transceiver is an infrared transceiver and the second transceiver is an infrared transceiver.

9. A system for providing wireless communications between a first electronic device and a second electronic device, the first electronic device generating an output signal substantively in compliance with a first format, the output signal provided via an output signal channel of the first electronic device, and the second electronic device configured to enable a Universal Serial Bus (“USB”) interface with an electronic device, the system comprising:
a first module and a second module, the first module configured for communicative coupling with the first electronic device and the second module configured for communicative coupling with the second electronic device;
the first module having a first connector, a converter circuit and a transmitter, the first connector configured to communicatively couple with the output signal channel of the first device and to accept the output signal, and the first connector communicatively coupled with the converter circuit;
the converter circuit having a translation element, the translation element configured to accept the output signal from the first connector and to generate a substantively USB compliant signal by translating the output signal into the substantively USB compliant signal, and the converter circuit communicatively coupled with the transmitter, wherein the substantively USB compliant signal is broadcast as a wireless communication;
the second module having a USB connector and a wireless receiver, wherein the USB connector is communicatively linked with the second electronics device; and
the wireless receiver communicatively coupled with the USB connector, and the wireless receiver for receiving the wireless transmission and providing the wireless transmission to the USB connector, whereby the substantively USB compliant signal is provided to the second electronic device.

10. The system of claim 9, wherein the first format is an electrical audio format.

11. The system of claim 9, wherein the first format is a serial digital communications format.

12. The system of claim 9, wherein the first format is an analog video format.

13. The system of claim 9, wherein the first format is a digital video format.

14. The system of claim 9 wherein the transmitter is a first transceiver and the receiver is a second transceiver, whereby the first and second modules enable bi-directional communications between the first electronic device and the second electronic device.

15. The system of claim 14 wherein the first transceiver is a radio signal transceiver and the second transceiver is a radio signal transceiver.

16. The system of claim 14 wherein the first transceiver is an infrared transceiver and the second transceiver is an infrared transceiver.

17. A system for providing wireless communications between a first electronic device and a second electronic device, the first electronic device generating an output signal substantively in compliance with a first format, the output signal provided via an output signal channel of the first electronic device, and the second electronic device configured to enable a standard communications interface with an electronic device, the system comprising:
a first module and a second module, the first module configured for communicative coupling with the first electronic device and the second module configured for communicative coupling with the second electronic device;
the first module having a first connector and a transmitter, the first connector configured to communicatively couple with the output signal channel of the first device, and the first connector communicatively coupled with the transmitter, wherein the output signal is broadcast via the transmitter as a wireless communication;
the second module having a conforming connector, a signal format converter circuit, and a wireless receiver, wherein the conforming connector is configured to conform with the communications standard and is communicatively linked with the second electronics device;
the wireless receiver communicatively coupled with the converter circuit, and the wireless receiver for receiving the wireless transmission and providing the wireless transmission to the converter circuit; and
the converter circuit having a translation element, the translation element configured to accept the wireless transmission from the wireless receiver and to generate a substantively compliant signal by translating the wireless transmission from the first format into the substantively compliant signal in substantive compliance with the communications standard, and the converter circuit communicatively coupled with the conforming connector, wherein the substantively compliant signal is provided to the second electronic device.

18. The system of claim 17, wherein the substantively compliant signal is substantially in conformance with a communications signal standard selected from the group consisting of RS232, RS422, NTSC/PAL, JPEG, MPEG, PCM, and IDE/Flash.

19. The system of claim 17, wherein the output signal is substantially in conformance with a communications standard selected from the group consisting of Bluetooth, IEEE802.11, GMS, CDMA, TDMA, and Ultrawide Band.

20. The system of claim 17, wherein the conforming connector is substantially in conformance with a connector standard selected from the group consisting of USB, IEEE1394, PCI, and PCMCIA.

21. A method for using a computer-readable medium, the computer-readable medium carrying one or more sequences of one or more instructions for buffering data, wherein the execution of the one or more sequences of the one or more instructions by one or more processors, causes the one or more processors to perform the steps of:
providing a first module and a second module;
a first module and a second module, the first module configured for communicative coupling with the first electronic device and the second module configured for communicative coupling with the second electronic device;
the first module having a first connector and a transmitter, the first connector configured to communicatively couple with the output signal channel of the first device, and the first connector communicatively coupled with the transmitter, wherein the output signal is broadcast via the transmitter as a wireless communication;
the second module having a USB connector, a signal format converter circuit, and a wireless receiver, wherein the USB connector is communicatively linked with the second electronics device;
the wireless receiver communicatively coupled with the converter circuit, and the wireless receiver for receiving the wireless transmission and providing the wireless transmission to the converter circuit; and
the converter circuit having a translation element, the translation element configured to accept the wireless transmission from the wireless receiver and to generate a substantively USB compliant signal by translating the wireless transmission from the first format into the substantively USB compliant signal, and the converter circuit communicatively coupled with the USB connector, wherein the substantively USB compliant signal is provided to the second electronic device.

22. The method of claim 21, wherein the computer-readable medium is reprogrammable.

23. The system of claim 22 wherein the transmitter is a first transceiver and the receiver is a second transceiver, whereby the first and second modules enable bi-directional communications between the first electronic device and the second electronic device.
